(19) United States
(12) Patent Application Publication
(10) Pub. No.: US 2024/0380580 A1
(43) Pub. Date: Nov. 14, 2024

(54) GLOBAL PHASE TRACKING AND PREDICTING METHOD SUITABLE FOR TWIN-FIELD QUANTUM KEY DISTRIBUTION SYSTEM

(71) Applicant: Nanjing University of Posts and Telecommunications, Jiangsu (CN)

(72) Inventors: Qin WANG, Jiangsu (CN); Jingyang LIU, Jiangsu (CN); Xingyu ZHOU, Jiangsu (CN)

(73) Assignee: Nanjing University of Posts and Telecommunications, Jiangsu (CN)

(21) Appl. No.: 18/032,570

(22) PCT Filed: Oct. 13, 2022
(86) PCT No.: PCT/CN2022/125039

§ 371 Date: Apr. 19, 2023

(30) Foreign Application Priority Data
May 16, 2022 (CN) 202210526818.1

(51) Int. Cl. H04L 9/08; G06N 3/0442

(52) U.S. Cl. CPC H04L 9/0852; G06N 3/0442

(57) ABSTRACT

A global phase tracking and predicting method suitable for a twin-field quantum key distribution system is provided. A time-aware sequence to sequence network (S2S) specially mounted on a field-programmable gate array (FPGA) is designed. In the global phase tracking and predicting method, global phase changes at a plurality of subsequent time points are tracked and predicted according to two-phase scan count and external environmental parameters acquired in real time, and the tracking and prediction results are then used to compensate phase disturbance in real time, thereby ensuring long-time global phase stability.

### TECHNICAL FIELD

The present invention belongs to the technical field of quantum information, and in particular to the channel disturbance of a global phase in a twin-field quantum key distribution (TF-QKD) system.

### DESCRIPTION OF RELATED ART

Quantum cryptography is the core of quantum communication, and the security of quantum cryptography directly determines the security of a quantum communication system. The security of quantum cryptography is based on the basic principle of quantum mechanics; and unconditional secure quantum communication can be provided for legitimate users (Alice and Bob) in principle by combining with the one-time pad (OTP) theorem proposed by Shannon. In recent years, the TF-QKD protocol and system proposed by researchers have made great progress theoretically and experimentally. The protocol can break the linear boundary of the code rate without a quantum repeater, thereby providing possibility for ultra-long-distance quantum secure communication. However, an existing twin-field quantum secure communication system is very sensitive to phase interference caused by the channel due to the structure similar to a symmetric Mach-Zehnder interference ring. This phase interference will directly lead to the unsatisfactory result of single-photon interference, which increases the error code. Therefore, ensuring the global phase stability of Alice and Bob is a prerequisite for secure and stable twin-field quantum key distribution. Existing technical means to stabilize the global phase mainly include two-phase scanning or four-phase scanning combined with time division multiplexing, etc. Such methods often require half or more time to complete phase point scanning, resulting in low overall efficiency of the system. Also, such methods have low accuracy in calibrating the global phase, resulting in great fluctuation of the code rate.

### SUMMARY

An objective of the present invention is to, for the above defects in the prior art, provide a global phase tracking and predicting method suitable for a twin-field quantum key distribution system. The method is applied to a TF-QKD system. The working mode of the TF-QKD system is divided into two stages: a quantum light stage and a reference light stage. In the reference light stage, according to the present invention, the global phase is tracked and predicted using a time-aware sequence to sequence network (S2S) mounted on a field-programmable gate array (FPGA), and the prediction result is used to compensate phase disturbance in real time, thereby ensuring single-photon interference stability.

A global phase tracking and predicting method suitable for a twin-field quantum key distribution system provided by the present invention includes the following steps.

Step 1: constructing a Filter matrix to filter a count of a detector to obtain a pure count;

Step 2: constructing an input vector xₜ of a T-LSTM network, where the input vector xₜ comprises a pure count Sₜ obtained by the filter matrix, and a temperature Tₜ and humidity Hₜ at a time t, and the input vectors at different times constitute an input time series; and calculating the weight of each input vector in the time series by an Attention layer; and

Step 3: inputting the time series with the weight into the T-LSTM network, and calculating and predicting the global phase.

Further, constructing a Filter matrix to filter a count of a detector to obtain a pure count in step 1 is specifically as follows.

Applying any initial voltage Vᵢ to a phase modulation PM for a duration T, and recording counts Ñ₀ and \tilde{M}₀ of two channels of the detector in this period; and then increasing the voltage by a half-wave voltage V_{half} of half of the PM, namely, applying a voltage Vᵢ+V_{half}/2 for another duration T and recording counts Ñ₁ and \tilde{M}₁ of the two channels of the detector in this period.

The noise suppression process of the filter matrix [symbol] may be expressed as:

[Ñ₀, \tilde{M}₀, Ñ₁, \tilde{M}₁] [symbol] =[N₀, M₀, N₁, M₁]=Sₜ, where [symbol] may represent a neural network.

Further, the Attention layer calculates the weight aₙ of each input vector in the time series, with the formula as follows:

aₙ=softmax(\vec{x}^{T}Wₐxₜ₋₅ₙ), where \vec{x} represents a matrix formed by all the input vectors in parallel, Wₐ is a weight value by training, and softmax is a normalized exponential function.

For example: the input time series is xₜ₋₄₅, xₜ₋₄₀, . . . , xₜ₋₅, xₜ. The attention layer assigns a weight aₙ(0≤n≤9) for each input vector xₜ₋₅ₙ(0≤n≤9).

Further, the T-LSTM network in the step 3 includes two layers of different T-LSTM blocks, namely a first T-LSTM Block and a second T-LSTM Block, where the first T-LSTM Block serves as an Encoder for an input time series, and the second T-LSTM Block serves as a Decoder for an output time series.

According to the present invention, the T-LSTM network includes 14 time-aware long-short term memory neural network units that are connected in sequence, where the first T-LSTM Block includes 10 time-aware long-short term memory neural network units, and the second T-LSTM Block includes 4 time-aware long-short term memory neural network units; and the calculation results of front and rear units are transmitted through an intermediate calculation result h to a cell structure C. A front end of each of the time-aware long-short term memory neural network units filters a two-phase scan count input into the network through the filter matrix. Then, the Attention layer applies weights to the first 10 node units to amplify the influence of important nodes in network transmission, and the last 4 node units output the multi-step phase prediction results.

Specifically, global phase prediction is composed of a series of repeated cycles; each of the cycles include three parts: acquiring data, such as a count, and a temperature Tₜ and a humidity Hₜ at a time t, required by an input vector, filtering the count, and inputting the input time series after weight assignment to the T-LSTM network and outputting a prediction result, where after a first decoder operation of the T-LSTM network is completed, the T-LSTM network outputs a voltage related to a first zero-phase voltage, a first global phase can be calculated by the voltage, and a second decoder operation is started. The second decoder operation is completed before the hold time of the first zero-phase voltage ends, the system outputs a second zero-phase voltage after the hold time ends, a third decoder operation is started at the same time, and so on. A third zero-phase voltage and a fourth zero-phase voltage are output, and then the next cycle is started. The method according to the present invention is used to track and predict the global phase of the twin-field quantum key distribution system, thereby ensuring the stability of single-photon interference.

Further, according to a global phase tracking and predicting method suitable for a twin-field quantum key distribution system, a weight matrix and a bias vector in the T-LSTM network are compressed and stored, which specifically includes the following steps.

Step 3.1: quantizing the weight matrix and the bias vector, and quantizing a 32-bit floating-point number D_{float32} into a fixed-point number D_{fix} with a 1-bit sign bit, a Nᵢₙₜ-bit integer place and a N_{dec}-bit decimal place, where the process is expressed as:

$${D}_{fix} = \{ \begin{matrix}{2}^{N - 1} - 1 & {D}_{float 32} > {2}^{{N}_{int}} - {2}^{{N}_{dec}} \\ round ( {D}_{float 32} \cdot {2}^{{N}_{dec}} ) & 0 \leq {D}_{float 32} \leq {2}^{{N}_{int}} - {2}^{- {N}_{dec}} \\ {2}^{N} + round ( {D}_{float 32} \cdot {2}^{{N}_{dec}} ) & - {2}^{{N}_{int}} \leq {D}_{float 32} < 0 \\ {2}^{N - 1} & {D}_{float 32} < - {2}^{{N}_{int}}\end{matrix} ,$$

where N=1+Nᵢₙₜ+N_{dec} represents the quantized digit bit number, and round(x) represents a rounding operation.

Step 3.2: pruning the quantized weight matrix, specifically as follows.

Each row of the weight matrix is divided into a plurality of blocks with equal size, and each block has an equal number of non-zero elements; and only a number with a maximum absolute value is retained in each block of the weight matrix, and other numbers in the block are replaced with zero.

Step 3.3: storing the pruned weight matrix, specifically as follows.

Non-zero elements Values in the weight matrix and Indices thereof in the corresponding block are stored; and for a sparse matrix Mₛₚₐᵣₛₑ^{i×j} each row of which is divided into N_{bank} blocks, the index length L_{index} is

$${L}_{index} = ceil [ {log}_{2} ( \frac{j}{{N}_{bank}} ) ] ,$$

where ceil(x) represents a ceiling operation.

Further, an activation function Sigmoid(x) in the T-LSTM network is fitted using a piecewise linear function, and the parameters of the piecewise linear function are stored in a LUT, which specifically includes the following steps.
(1) Evenly dividing Sigmoid(x) into N_{pw} segments over [−8,8], where N_{pw}=2^{α}, α being a positive integer;
(2) Fitting the i^{th} segment of Sigmoid(x) to a linear function y=kᵢx+bᵢ, where 0≤i<N_{pw};
(3) Quantizing and storing kᵢ and bᵢ (0≤i<N_{pw}) into the LUT; and
(4) Taking kᵢ and bᵢ from the LUT according to the value of an input variable, and calculating and outputting y=kᵢx+bᵢ.

Further, an activation function Tanh(x) in the T-LSTM network is fitted using a piecewise linear function, and the parameters of the piecewise linear function are stored in the LUT, which specifically includes the following steps.
(1) Evenly dividing Tanh(x) into N_{pw} segments over [−4,4], where N_{pw}=2^{α}, α being a positive integer;
(2) Fitting the i^{th} segment of Tanh(x) to a linear function y=kⱼx+bⱼ, where 0≤j<N_{pw};
(3) Quantizing and storing kⱼ and bⱼ (0≤j<N_{pw}) into the LUT; and
(4) Taking kⱼ and bⱼ from the LUT according to the value of an input variable, and calculating and outputting y=kⱼx+bⱼ.

Further, a global phase tracking and predicting method suitable for a twin-field quantum key distribution system further includes:

Step 4: deploying the Filter matrix, the Attention layer and the T-LSTM network subjected to model compression and activation function fitting to a FPGA.

The FPGA includes an ADC Driver, a Pulse Counter, a Controller, a signal generator SigGen, the Filter matrix, the Attention layer, a multiplexer MUX, a T-LSTM operation module, a DAC Driver and a clock domain crossing (CDC) module.

The Controller controls the SigGen to sequentially generate signals corresponding to Vᵢ and Vᵢ+V_{half}/2 respectively for a duration T, and controls the MUX to enable the signal of the SigGen to pass through. The signal of the SigGen passes through the CDC and is fed to the DAC Driver for driving the PM; meanwhile, after a short latency, the Controller controls the Pulse Counter via the CDC to start counting. After counting is completed, the counting value is transmitted to the Filter matrix through the CDC, and arrives at the MUX through operation in the Attention layer and T-LSTM. Under the control of the Controller, the signal of T-LSTM passes through the MUX and is fed to the DAC Driver through the CDC for acquiring the global phase.

The present invention has the following beneficial effects: according to the present invention, the above mode is loaded into the FPGA, the parameter quantization process is completed by converting the floating-point number into the fixed-point number, and the quantized parameters include the weight matrix and the bias vector, so that the model can directly use a DSP slice to perform efficient multiplication; the load balance is adapted to the sparsity through block balance pruning; and efficient storage of the parameters and efficient operation of the activation function are realized through address-based storage of the non-zero elements and the piecewise fitting of the activation function, thereby finally ensuring the highly parallelized operation results of the model on the commercial FPGA and achieving microsecond-level input and output.

Compared with the traditional method for calibrating the global phase through time division multiplexing, the present invention tracks and predicts the global phase by the time-aware S2S model mounted on the FPGA and can greatly improve the efficiency and accuracy of global phase compensation, thereby improving the transmission efficiency of the whole TF-QKD system.

### BRIEF DESCRIPTION OF THE DRAWINGS

FIG. 1 is a structural diagram of a model according to the solution of the present invention.

FIG. 2 is a schematic diagram of a quantization process according to the present invention.

FIG. 3 is a schematic diagram of a pruning process according to the present invention.

FIG. 4 is a schematic diagram of a storage process according to the present invention.

FIG. 5 is a schematic diagram of performing a Sigmoid function operation according to the present invention.

FIG. 6 is an error curve of fitting a Sigmoid function according to the present invention.

FIG. 7 is an error curve of fitting a Tanh function according to the present invention.

FIG. 8 is a top-level block diagram of an FPGA project in a model deployment process according to the present invention.

FIG. 9 is a comparison diagram of an interference visibility achieved by the present invention and a traditional two-phase scanning method.

### DESCRIPTION OF THE EMBODIMENTS

The technical solutions of the present invention are further described below in detail with reference to the accompanying drawings of the specification.

A global phase tracking and predicting method suitable for a twin-field quantum key distribution system includes the following specific steps.

Step 1: a Filter matrix is constructed to filter a count of a Clarlie-side detector to obtain a pure count, which is specifically as follows:

Any initial voltage Vᵢ is applied to a Clarlie-side phase modulation PM for 5 μs, and counts Ñ₀ and \tilde{M}₀ of two channels of the detector in this period are recorded; and then the voltage is increased by a half-wave voltage V_{half} of half of the PM, that is, a voltage Vᵢ+V_{half}/2 is applied for 5 μs and counts Ñ₁ and \tilde{M}₁ of the two channels of the detector in this period are recorded.

Due to the limitation of the light pulse intensity and the maximum counting rate of the detector, the output counts Ñ and \tilde{M} of the two channels of the Clarlie-side detector will be seriously disturbed by noise and level fluctuation, which may be expressed as:

Ñ=N+\hat{ε}+\hat{δ}, \tilde{M}=M+\hat{ε}+\hat{δ}, where N and M respectively represent the pure counts of the two channels of the detector, \hat{ε} represents additive noise, and \hat{δ} represents an error count introduced by level fluctuation; and when the amount of data is large, the additive noise \hat{ε} complies with Gaussian distribution.

The noise suppression process of the filter matrix [symbol] may be expressed as:

[Ñ₀, \tilde{M}₀, Ñ₁, \tilde{M}₁] [symbol] =[N₀, M₀, N₁, M₁]=Sₜ, where [symbol] may be expressed as various common neural networks, such as a feedforward neural network.

Step 2: input vectors xₜ are constructed, and the weight of each input vector is calculated by an Attention layer.

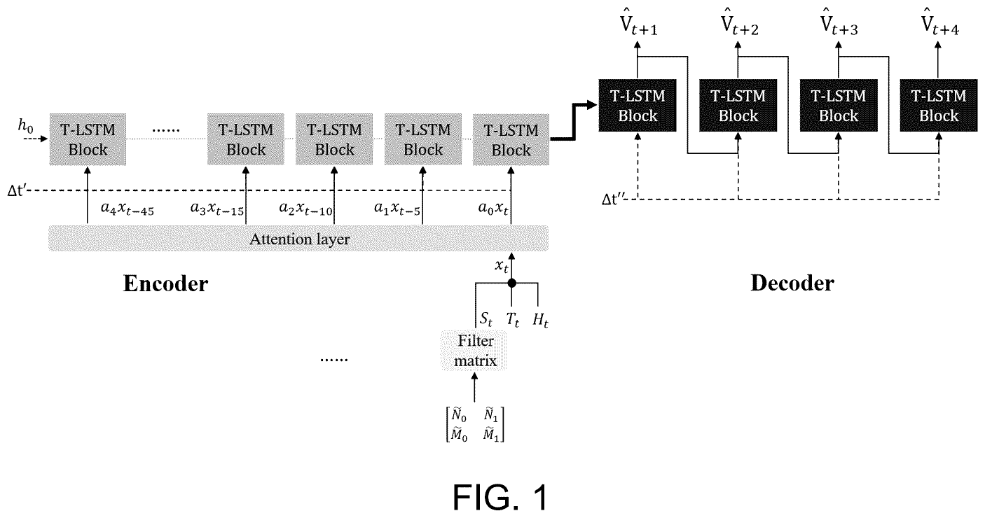

As shown in FIG. 1, the input of the attention layer is a pure count Sₜ obtained by the filter matrix, a vector x composed of a temperature Tₜ and a humidity Hₜ at a time t, and historical data xₜ₋₄₅, xₜ₋₄₀, . . . , xₜ₋₅. The attention layer assigns a weight aₙ(0≤n≤9) for each input vector xₜ₋₅ₙ(0≤n≤9), and

aₙ=softmax(\vec{x}^{T}Wₐxₜ₋₅ₙ), where \vec{x} represents a matrix formed by all the input vectors in parallel, Wₐ is a weight value by training, and softmax is a normalized exponential function.

Step 3: the time series with the weight is input into the T-LSTM network, and a global phase is calculated and obtained.

As shown in FIG. 1, the T-LSTM network includes two layers of different T-LSTM Blocks, namely a first T-LSTM Block and a second T-LSTM Block, where the first T-LSTM Block serves as an Encoder for an input time series, and the second T-LSTM Block serves as a Decoder for an output time series.

The operation process of each T-LSTM Block is as follows:

$${i}_{t} = Sigmoid ( {W}_{i} \cdot {h}_{t - 1} + {U}_{i} \cdot {x}_{t} + {P}_{i} \cdot {C}_{t - 1} + {b}_{i} ) , \\ {f}_{t} = Sigmoid ( {W}_{f} \cdot {h}_{t - 1} + {U}_{f} \cdot {x}_{t} + {P}_{f} \cdot {C}_{t - 1} + {b}_{f} ) , \\ {\tilde{C}}_{t} = Tanh ( {W}_{c} \cdot {h}_{t - 1} + {U}_{c} \cdot {x}_{t} + {b}_{c} ) , \\ {C}_{t} = {i}_{t} ⊗ {\tilde{C}}_{t} + {f}_{t} ⊗ [ {C}_{t - 1} \cdot g ( Δ t ) ] , \\ {o}_{t} = Sigmoid ( {W}_{o} \cdot {h}_{t - 1} + {U}_{o} \cdot {x}_{t} + {P}_{o} \cdot {C}_{t} + {b}_{o} ) , \\ {h}_{t} = {o}_{t} ⊗ Tanh ( {C}_{t} ) .$$

Where W∈R^{d×d}, U∈R^{d×m} and P∈R^{d×d} represent weight matrices, and b∈R^{d} represents the corresponding bias vector. iₜ∈R^{d}, fₜ∈R^{d} and oₜ∈R^{d} respectively represent an input gate, a forget gate and an output gate; and Cₜ∈R^{d} and \tilde{C}ₜ∈R^{d} respectively represent a cell state and a candidate cell state at the time t. hₜ₋₁∈R^{d} And hₜ∈R^{d} respectively represent a hidden state of the previous time and the current time. ⊗ operator represents a dot product of vector elements. A time interval is introduced into the encoder and the decoder through g(Δt)=1/Δt×10⁻⁶. Sigmoid(x) and Tanh(x) are activation functions, with the expressions as follows:

$$Sigmoid ( x ) = \frac{1}{1 + {e}^{- x}} , \\ Tanh ( x ) = \frac{{e}^{x} - {e}^{- x}}{{e}^{x} + {e}^{- x}} .$$

So far, the introduction of the model building process is completed.

Step 3.1: the weight matrix and the bias vector in the T-LSTM network are compressed and stored, which includes the following steps.

Step 3.1.1: the weight matrix and the bias vector are quantized.

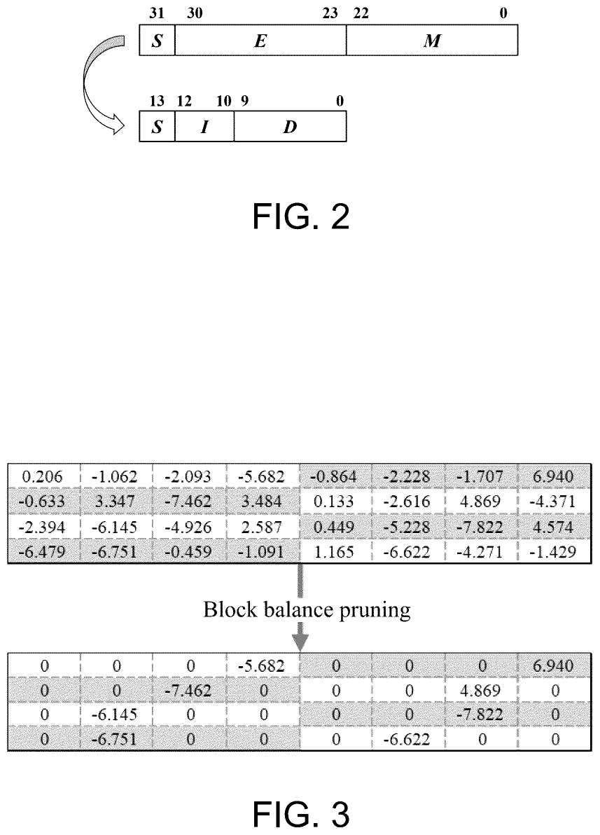

For the weight matrix and the bias vector, the floating-point number is converted into a fixed-point number for completing parameter quantization. The advantage of using the quantization method is that efficient multiplication can be performed directly using a DSP Slice, the quantization process is simple, and the quantization error is easily controlled. The process of quantizing a 32-bit floating-point number D_{float32} into a fixed-point number D_{fix} that can be operated in the FPGA and has a 1-bit sign bit, a Nᵢₙₜ-bit integer place and a N_{dec}-bit decimal place may be expressed as:

$${D}_{fix} = \{ \begin{matrix}{2}^{N - 1} - 1 & {D}_{float 32} > {2}^{{N}_{int}} - {2}^{{N}_{dec}} \\ round ( {D}_{float 32} \cdot {2}^{{N}_{dec}} ) & 0 \leq {D}_{float 32} \leq {2}^{{N}_{int}} - {2}^{- {N}_{dec}} \\ {2}^{N} + round ( {D}_{float 32} \cdot {2}^{{N}_{dec}} ) & - {2}^{{N}_{int}} \leq {D}_{float 32} < 0 \\ {2}^{N - 1} & {D}_{float 32} < - {2}^{{N}_{int}}\end{matrix} ,$$

Where N=1+Nᵢₙₜ+N_{dec} represents the quantized digit bit number, and round(x) represents a rounding operation. When D_{float32} does not exceed the quantization range of −2^{N}^{ᵢₙₜ}≤D_{float32}≤2^{N}^{ᵢₙₜ}−2^{-N}^{_{dec}}, the quantization error does not exceed 2^{-N}^{_{dec}}⁻¹. The quantization range and the quantization error may be directly adjusted by changing the values of Nᵢₙₜ and N_{dec}. After debugging, the fixed numbers of Nᵢₙₜ=3 and N_{dec}=10 are used. At this time, the quantization range is [−8,7.999], and the maximum quantization error is 4.88×10⁻⁴. As shown in FIG. 2, through quantization, the storage space occupied by each value of the weight matrix and the bias vector is reduced from 32 bits to 14 bits, and reduced by 56.3%.

Step 3.1.2: the quantized weight matrix is pruned.

Hardware-friendly block balance pruning is used during model pruning. After the weight matrix is pruned in this way, each row is divided into a plurality of blocks with an equal size, and each block has an equal number of non-zero elements. Based on this characteristic, the pruned weight matrix can conveniently realize load balance when being operated on the FPGA. The input of a block balance pruning algorithm includes: a weight matrix M_{dense}^{i×j} dense to be pruned, an all-zero matrix Mₛₚₐᵣₛₑ^{i×j}, the number N_{bank} of blocks into which each row of the matrix is divided, and a number k of non-zero elements in each block. The algorithm flow may be described in pseudocode as follows:

```
  for each row of M_{dense}^{i×j} do,
  evenly divide this row Mᵢ into N_{bank} blocks,
  for each block of Mᵢ do,
  find k numbers D₁, D₂, ..., Dₖ with a maximum absolute value in the
block, and recording their indices Index₁, Index₂, ..., Indexₖ,
  replace the elements of Mₛₚₐᵣₛₑ^{i×j} with the indices being Index₁, Index₂,
..., indexₖ with D₁, D₂, ..., Dₖ,
  endfor,
  endfor.
```

The output of the algorithm is a sparse matrix Mₛₚₐᵣₛₑ^{i×j} with a sparsity equal to 1−kN_{bank}/j. As shown in FIG. 3, the 4×8 matrix M_{dense}^{4×8} is subjected to block balance pruning by taking N_{bank}=2 and k=1 as an example, and the sparsity of the pruned matrix Mₛₚₐᵣₛₑ^{4×8} is 75%. In the T-LSTM model, to ensure the balance of the load, N_{bank} and k used by the weight matrices with the equal dimensionality during pruning are the same. Moreover, to achieve the multiplexing of the calculating resource, the weight matrices of the encoder and the decoder are pruned using the same parameters. After pruning, the prediction accuracy of the model will be greatly reduced, and the accuracy can be restored by retraining.

Step 3.1.3: the quantized bias vector and the pruned and quantized weight matrix are stored.

When a sparse weight matrix is stored, it is only necessary to store non-zero elements Values and Indices thereof in the corresponding block. For a sparse matrix Mₛₚₐᵣₛₑ^{i×j} each row of which is divided into N_{bank} blocks, the index length L_{index} is:

$${L}_{index} = ceil [ {log}_{2} ( \frac{j}{{N}_{bank}} ) ] ,$$

where ceil(x) represents a ceiling operation.

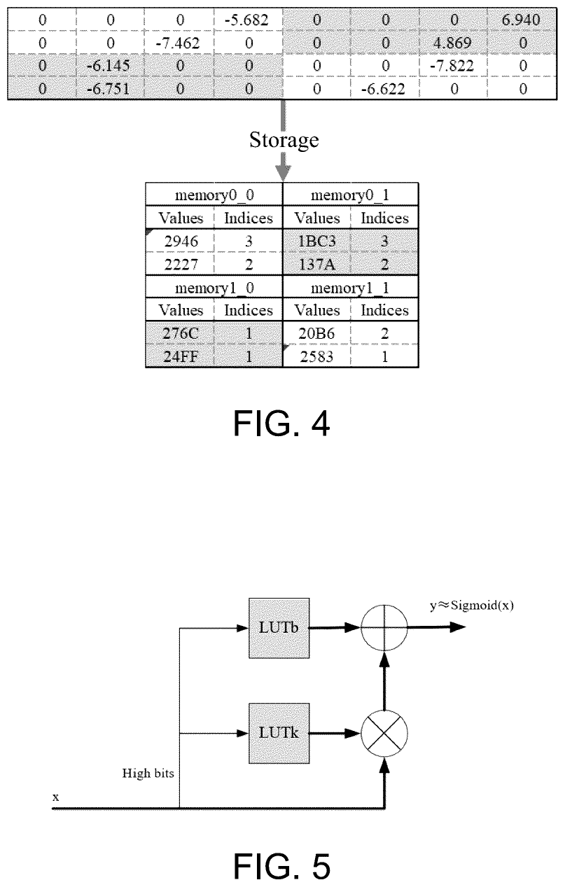

The 4×8 quantized matrix listed in FIG. 3 is stored as shown in FIG. 4, where the Values and Indices are expressed hexadecimally, the bit width of the Values is 14 bits, and the bit width of the Indices is 2 bits. The row number of the matrix stored in each memory is adjustable, and the value herein is 2.

Step 3.2: the activation functions Sigmoid(x) and Tanh(x) in the T-LSTM network are fitted.

The model includes two activation function operations, namely, Sigmoid(x) and Tanh(x). The two functions both include an e exponent operation and a division operation, and the implementation of the two operations on the FPGA is very inefficient. Benefited from the robustness of the neural network, some errors may occur during the activation function operation without affecting the final inference result. Taking this as a breakthrough point, the activation function is fitted by using a piecewise linear function, and the parameters of the piecewise linear function are stored in a LUT, thereby achieving a solution with balanced speed, resource consumption and accuracy. Taking Sigmoid(x) as an example, the fitting implementation process of Sigmoid(x) is as follows.
(1) Sigmoid(x) is evenly divided into N_{pw} segments over [−8,8], where N_{pw}=2^{α}, α being a positive integer;
(2) The i^{th} segment of Sigmoid(x) is fitted to a linear function y=kᵢx+bᵢ, where 0≤i<N_{pw};
(3) The kᵢ and bᵢ (0≤i<N_{pw}) are quantized and stored in a LUT, where the quantization method is the same as the method for quantizing the weight matrix and the bias vector in the step 3.1.1; and
(4) The kᵢ and bᵢ are taken from the LUT according to the value of an input variable, and y=kᵢx+bᵢ is calculated and output.

Due to the tiny change of Sigmoid(x) over (−∞, −8) and (8, +∞), within 3.4×10⁻⁴, [−8,8] is selected as a segment interval. Sigmoid(x) is segmented in a limited interval, and the absolute value of the boundary and the number of the segments both are set as the integer power of 2. This is such that when a parameter is taken from the LUT, the high bit of the input variable may directly serve as an address (as shown in FIG. 5) of the LUT, and the address of the LUT is confirmed without comparing the input variable with the segmented boundary value for many times.

The fitting implementation process of Tanh(x) is as follows.
(1) Tanh(x) is evenly divided into N_{pw} segments over [−4,4], where N_{pw}=2^{α}, α being a positive integer;
(2) The i^{th} segment of Tanh(x) is fitted to a linear function y=kⱼx+bⱼ, where 0≤j<N_{pw};
(3) The kⱼ and bⱼ (0≤j<N_{pw}) are quantized and stored in a LUT, where the quantization method is the same as the method for quantizing the weight matrix and the bias vector in the step 3.1.1; and
(4) The kⱼ and bⱼ are taken from the LUT according to the value of an input variable, and y=kⱼx+bⱼ is calculated and output.

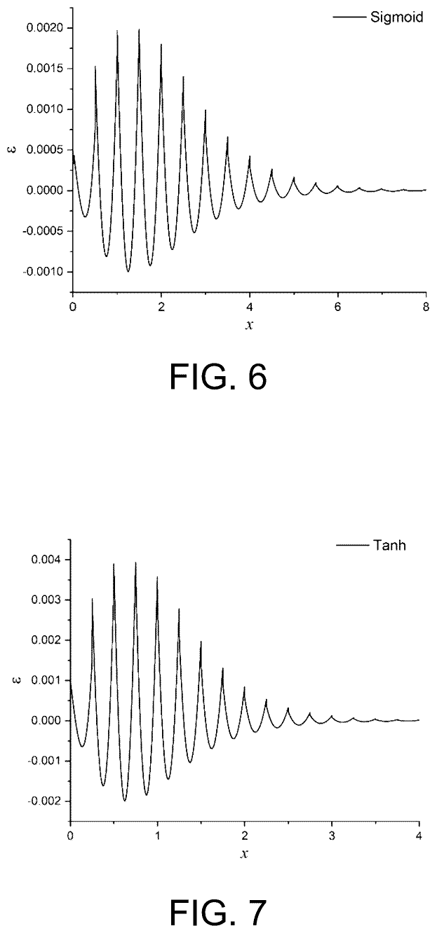

Sigmoid(x) and Tanh(x) are fitted respectively using the 32-segment linear function, and the fitting errors & are respectively shown in FIG. 6 and FIG. 7. The fitting errors of the two activation functions are in the order of magnitude 10⁻⁴˜10⁻³, and the fitting errors have little influence on the inference accuracy of the model.

Step 4: the Filter matrix, the Attention layer and the T-LSTM network subjected to model compression and activation function fitting are deployed to the FPGA.

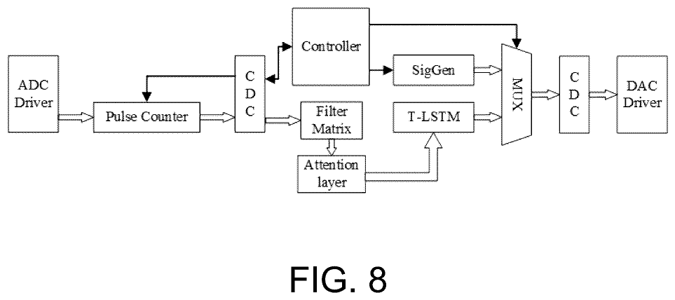

The top-level block diagram of the FPGA is shown in FIG. 8. This project includes three clock domains: 65 MHz, 200 MHz and 125 MHz. The 65 MHz clock domain includes an ADC Driver and a Pulse Counter; the 200 MHz clock domain includes a Controller, a signal generator SigGen, a Filter matrix, an Attention layer, a multiplexer MUX and a T-LSTM operation module; and the 125 MHz clock domain includes a DAC Driver. When signals are transmitted between different clock domains, the clock domain crossing (CDC) module serves as a transit. In the figure, the solid arrow represents a single-bit signal, the hollow arrow represents a multi-bit signal, and the arrow direction represents the transmission direction of the signal.

When the FPGA works, the Controller controls the SigGen to sequentially generate signals corresponding to Vᵢ and Vᵢ+V_{half}/2 respectively for 5 μs, and controls the MUX to enable the signal of the SigGen to pass through. The signal of the SigGen passes through the CDC and is fed to the DAC Driver for driving the PM; meanwhile, after a short latency, the Controller controls the Pulse Counter through the CDC to start counting. After counting is completed, the counting value is transmitted to the Filter matrix through the CDC, and arrives at the MUX through the T-LSTM operation after the Attention layer assigns the weight. Under the control of the Controller, the signal of T-LSTM passes through the MUX and is fed to the DAC Driver through the CDC for acquiring the global phase.

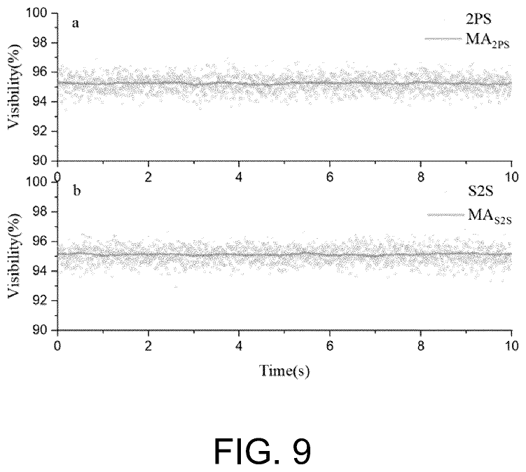

FIG. 9 is a comparison diagram of interference visibility of a S2S solution according to the present invention and a traditional two-phase scanning 2PS solution when the optical fiber length is 500 km. FIG. 9 (a) and FIG. 9 (b) are respectively images of the interference visibility changes of the 2PS solution and the S2S solution with time. The hollow circle in the figure represents the interference visibility, and the solid line represents the moving average (MA) of the interference visibility. It can be seen from the figure that the interference visibility of the S2S solution is very close to that of the 2PS solution. Specifically, the interference visibility distribution of the 2PS solution is concentrated at 95.27%, and the standard deviation is 0.56%; and the interference visibility of the S2S solution is concentrated at 95.13%, and the standard deviation is 0.55%. However, the S2S solution can realize a transmission efficiency of 84.86%, and the 2PS solution only can achieve 24.29%. In the work of other teams, the transmission efficiency in the 500 km optical fiber is close to 50%.

In conclusion, the experiment of the present invention verifies a global phase tracking and predicting method suitable for a twin-field quantum key distribution system. The method for predicting the zero-point phase voltage by using the S2S model accelerated by the FPGA can increase the transmission efficiency of the TF-QKD system to 84% or more, and also can ensure that the interference visibility of the system is kept at the same level as that of the traditional solution. In addition, the solution of the present invention can be extended to any QKD protocol and system.

The above is only the preferred embodiment of the present invention. The protection scope of the present invention is not limited to the above embodiment, and all equivalent modifications or changes made by those of ordinary skill in the art according to the disclosure of the present invention should be included in the protection scope described in the claims.

1. A global phase tracking and predicting method suitable for a twin-field quantum key distribution system, comprising following steps:
step 1: constructing a filter matrix to filter a count of a detector to obtain a pure count;
step 2: constructing an input vector xₜ of a Time-Aware Long-Short Term Memory (T-LSTM) network, where the input vector xₜ comprises a pure count Sₜ obtained by the filter matrix, and a temperature Tₜ and humidity Hₜ at a time t, and input vectors at different times constitute an input time series; and
calculating a weight of each input vector in the input time series by an attention layer; and
step 3: inputting a time series with the weight into the T-LSTM network, and calculating and predicting a global phase.

2. The global phase tracking and predicting method suitable for the twin-field quantum key distribution system according to claim 1, wherein constructing the filter matrix to filter the count of the detector to obtain the pure count in step 1 comprises:
applying any initial voltage Vᵢ to a phase modulation PM for a duration T, and recording counts Ñ₀ and \tilde{M}₀ of two channels of the detector in the duration T; and then increasing a voltage by a half-wave voltage V_{half} of half of the PM, namely, applying a voltage Vᵢ+V_{half}/2 for another duration T and recording counts Ñ₁ and \tilde{M}₁ of two channels of the detector in the another duration T,
where a noise suppression process of the filter matrix [symbol] is expressed as:
[Ñ₀, \tilde{M}₀, Ñ₁, \tilde{M}₁] [symbol] =[N₀, M₀, N₁, M₁]=Sₜ, where [symbol] can represent is realized in a neural network.

3. The global phase tracking and predicting method suitable for the twin-field quantum key distribution system according to claim 1, wherein
the attention layer calculates the weight aₙ of each input vector in the time series with the formula as follows:
$${a}_{n} = softmax ( {\vec{x}}^{T} {W}_{a} {x}_{t - 5 n} ) ,$$
where \vec{x} represents a matrix formed by all the input vectors in parallel, Wₐ is a weight value obtained by training, and softmax is a normalized exponential function.

4. The global phase tracking and predicting method suitable for the twin-field quantum key distribution system according to claim 1, wherein in the step 3, the T-LSTM network comprises a first T-LSTM Block and a second T-LSTM Block, the first T-LSTM Block serving as an encoder for the input time series, and the second T-LSTM Block serving as a decoder for an output time series.

5. The global phase tracking and predicting method suitable for the twin-field quantum key distribution system according to claim 1, wherein a weight matrix and a bias vector in the T-LSTM network are compressed and stored, which comprises following steps:
step 3.1: quantizing the weight matrix and the bias vector, and quantizing a 32-bit floating-point number D_{float32} into a fixed-point number D_{fix} with a 1-bit sign bit, a Nᵢₙₜ-bit integer bit and a N_{dec}-bit decimal bit, where the process is expressed as:
$${D}_{fix} = \{ \begin{matrix}{2}^{N - 1} - 1 & {D}_{float 32} > {2}^{{N}_{int}} - {2}^{{N}_{dec}} \\ round ( {D}_{float 32} \cdot {2}^{{N}_{dec}} ) & 0 \leq {D}_{float 32} \leq {2}^{{N}_{int}} - {2}^{- {N}_{dec}} \\ {2}^{N} + round ( {D}_{float 32} \cdot {2}^{{N}_{dec}} ) & - {2}^{{N}_{int}} \leq {D}_{float 32} < 0 \\ {2}^{N - 1} & {D}_{float 32} < - {2}^{{N}_{int}}\end{matrix} ,$$
where N=1+Nᵢₙₜ+N_{dec} represents a quantized digit bit number, and round(x) represents a rounding operation;
step 3.2: pruning a quantized weight matrix as follows:
each row of the weight matrix is divided into a plurality of blocks with equal size, only a weight value with a maximum absolute value is retained in each block of the weight matrix, and other weight values in the block are replaced with zero; and
step 3.3: storing a pruned weight matrix as follows:
non-zero elements in the weight matrix and indices of the non-zero elements in a corresponding block are stored; and an index length L_{index} for a sparse matrix Mₛₚₐᵣₛₑ^{i×j} sparse having each row divided into N_{bank} blocks is
$${L}_{index} = ceil [ {log}_{2} ( \frac{j}{{N}_{bank}} ) ] ,$$
where ceil(x) represents a ceiling operation.

6. The global phase tracking and predicting method suitable for the twin-field quantum key distribution system according to claim 1, wherein an activation function Sigmoid(x) in the T-LSTM network is fitted using a piecewise linear function, and parameters of the piecewise linear function are stored in a lookup table, which comprises following steps:
(1) evenly dividing Sigmoid(x) into N_{pw} segments over [−8,8], where N_{pw}=2^{α}, α being a positive integer;
(2) fitting a i^{th} segment of Sigmoid(x) to a linear function y=kᵢx+bᵢ, where 0≤i<N_{pw};
(3) quantizing and storing kᵢ and bᵢ into the lookup table, where 0≤i<N_{pw}; and
(4) taking kᵢ and bᵢ from the lookup table according to a value of an input variable, and calculating and outputting y=kᵢx+bᵢ.

7. The global phase tracking and predicting method suitable for the twin-field quantum key distribution system according to claim 1, wherein an activation function Tanh(x) in the T-LSTM network is fitted using a piecewise linear function, and parameters of the piecewise linear function are stored in a lookup table, which comprises following steps:
(1) evenly dividing Tanh(x) into N_{pw} segments over [−4,4], where N_{pw}=2^{α}, α being a positive integer;
(2) fitting a i^{th} segment of Tanh(x) to a linear function y=kⱼx+bⱼ, where 0≤j<N_{pw};
(3) quantizing and storing kⱼ and bⱼ into the lookup table, where 0≤j<N_{pw}; and
(4) taking kⱼ and bⱼ from the lookup table according to a value of an input variable, and calculating and outputting y=kⱼx+bⱼ.

8. The global phase tracking and predicting method suitable for the twin-field quantum key distribution system according to claim 1, further comprising:
step 4: deploying the filter matrix, the attention layer and the T-LSTM network to a field-programmable gate array (FPGA),
the FPGA comprising an analog-to-digital (ADC) driver, a pulse counter, a controller, a signal generator, the filter matrix, the attention layer, a multiplexer, a T-LSTM operation module, a digital-to-analog (DAC) driver and a clock domain crossing (CDC) module;
wherein the controller controls the signal generator to sequentially generate signals corresponding to Vᵢ and Vᵢ+V_{half}/2 respectively for a duration T, and controls the multiplexer to enable a signal of the signal generator to pass through; the signal of the signal generator passes through the CDC and is fed to the DAC driver for driving a phase modulation; meanwhile, after a short latency, the controller controls the pulse counter via the CDC to start counting; after counting is completed, a counting value is transmitted to the filter matrix through the CDC, and arrives at the multiplexer through operation in the attention layer and the T-LSTM operation module; under a control of the controller, a signal of the T-LSTM operation module passes through the multiplexer and is fed to the DAC driver through the CDC for acquiring the global phase.

9. The global phase tracking and predicting method suitable for the twin-field quantum key distribution system according to claim 2, further comprising:
step 4: deploying the filter matrix, the attention layer and the T-LSTM network to a_field-programmable gate array (FPGA),
the FPGA comprising an analog-to-digital (ADC) driver, a pulse counter, a controller, a signal generator, the filter matrix, the attention layer, a multiplexer, a T-LSTM operation module, a digital-to-analog (DAC) driver and a clock domain crossing (CDC) module;
wherein the controller controls the signal generator to sequentially generate signals corresponding to Vᵢ and Vᵢ+V_{half}/2 respectively for a duration T, and controls the multiplexer to enable a signal of the signal generator to pass through; the signal of the signal generator passes through the CDC and is fed to the DAC driver for driving the phase modulation; meanwhile, after a short latency, the controller controls the pulse counter via the CDC to start counting; after counting is completed, a counting value is transmitted to the filter matrix through the CDC, and arrives at the multiplexer through operation in the attention layer and the T-LSTM operation module; under a control of the controller, a signal of the T-LSTM operation module passes through the multiplexer and is fed to the DAC driver through the CDC for acquiring the global phase.

10. The global phase tracking and predicting method suitable for the twin-field quantum key distribution system according to claim 3, further comprising:
step 4: deploying the filter matrix, the attention layer and the T-LSTM network to a_field-programmable gate array (FPGA),
the FPGA comprising an analog-to-digital (ADC) driver, a pulse counter, a controller, a signal generator, the filter matrix, the attention layer, a multiplexer, a T-LSTM operation module, a digital-to-analog (DAC) driver and a clock domain crossing (CDC) module;
wherein the controller controls the signal generator to sequentially generate signals corresponding to Vᵢ and Vᵢ+V_{half}/2 respectively for a duration T, and controls the multiplexer to enable a signal of the signal generator to pass through; the signal of the signal generator passes through the CDC and is fed to the DAC driver for driving a phase modulation; meanwhile, after a short latency, the controller controls the pulse counter via the CDC to start counting; after counting is completed, a counting value is transmitted to the filter matrix through the CDC, and arrives at the multiplexer through operation in the attention layer and the T-LSTM operation module; under a control of the controller, a signal of the T-LSTM operation module passes through the multiplexer and is fed to the DAC driver through the CDC for acquiring the global phase.

11. The global phase tracking and predicting method suitable for the twin-field quantum key distribution system according to claim 4, further comprising:
step 4: deploying the filter matrix, the attention layer and the T-LSTM network to a_field-programmable gate array (FPGA),
the FPGA comprising an analog-to-digital (ADC) driver, a pulse counter, a controller, a signal generator, the filter matrix, the attention layer, a multiplexer, a T-LSTM operation module, a digital-to-analog (DAC) driver and a clock domain crossing (CDC) module;
wherein the controller controls the signal generator to sequentially generate signals corresponding to Vᵢ and Vᵢ+V_{half}/2 respectively for a duration T, and controls the multiplexer to enable a signal of the signal generator to pass through; the signal of the signal generator passes through the CDC and is fed to the DAC driver for driving a phase modulation; meanwhile, after a short latency, the controller controls the pulse counter via the CDC to start counting; after counting is completed, a counting value is transmitted to the filter matrix through the CDC, and arrives at the multiplexer through operation in the attention layer and the T-LSTM operation module; under a control of the controller, a signal of the T-LSTM operation module passes through the multiplexer and is fed to the DAC driver through the CDC for acquiring the global phase.

12. The global phase tracking and predicting method suitable for the twin-field quantum key distribution system according to claim 5, further comprising:
step 4: deploying the filter matrix, the attention layer and the T-LSTM network to a_field-programmable gate array (FPGA),
the FPGA comprising an analog-to-digital (ADC) driver, a pulse counter, a controller, a signal generator, the filter matrix, the attention layer, a multiplexer, a T-LSTM operation module, a digital-to-analog (DAC) driver and a clock domain crossing (CDC) module;
wherein the controller controls the signal generator to sequentially generate signals corresponding to Vᵢ and Vᵢ+V_{half}/2 respectively for a duration T, and controls the multiplexer to enable a signal of the signal generator to pass through; the signal of the signal generator passes through the CDC and is fed to the DAC driver for driving a phase modulation; meanwhile, after a short latency, the controller controls the pulse counter via the CDC to start counting; after counting is completed, a counting value is transmitted to the filter matrix through the CDC, and arrives at the multiplexer through operation in the attention layer and the T-LSTM operation module; under a control of the controller, a signal of the T-LSTM operation module passes through the multiplexer and is fed to the DAC driver through the CDC for acquiring the global phase.

13. The global phase tracking and predicting method suitable for the twin-field quantum key distribution system according to claim 6, further comprising:
step 4: deploying the filter matrix, the attention layer and the T-LSTM network to a_field-programmable gate array (FPGA),
the FPGA comprising an analog-to-digital (ADC) driver, a pulse counter, a controller, a signal generator, the filter matrix, the attention layer, a multiplexer, a T-LSTM operation module, a digital-to-analog (DAC) driver and a clock domain crossing (CDC) module;
wherein the controller controls the signal generator to sequentially generate signals corresponding to Vᵢ and Vᵢ+V_{half}/2 respectively for a duration T, and controls the multiplexer to enable a signal of the signal generator to pass through; the signal of the signal generator passes through the CDC and is fed to the DAC driver for driving a phase modulation; meanwhile, after a short latency, the controller controls the pulse counter via the CDC to start counting; after counting is completed, a counting value is transmitted to the filter matrix through the CDC, and arrives at the multiplexer through operation in the attention layer and the T-LSTM operation module; under a control of the controller, a signal of the T-LSTM operation module passes through the multiplexer and is fed to the DAC driver through the CDC for acquiring the global phase.

14. The global phase tracking and predicting method suitable for the twin-field quantum key distribution system according to claim 7, further comprising:
step 4: deploying the filter matrix, the attention layer and the T-LSTM network to a_field-programmable gate array (FPGA),
the FPGA comprising an analog-to-digital (ADC) driver, a pulse counter, a controller, a signal generator, the filter matrix, the attention layer, a multiplexer, a T-LSTM operation module, a digital-to-analog (DAC) driver and a clock domain crossing (CDC) module;
wherein the controller controls the signal generator to sequentially generate signals corresponding to Vᵢ and Vᵢ+V_{half}/2 respectively for a duration T, and controls the multiplexer to enable a signal of the signal generator to pass through; the signal of the signal generator passes through the CDC and is fed to the DAC driver for driving a phase modulation; meanwhile, after a short latency, the controller controls the pulse counter via the CDC to start counting; after counting is completed, a counting value is transmitted to the filter matrix through the CDC, and arrives at the multiplexer through operation in the attention layer and the T-LSTM operation module; under a control of the controller, a signal of the T-LSTM operation module passes through the multiplexer and is fed to the DAC driver through the CDC for acquiring the global phase.
